(19) United States
(12) Patent Application Publication
(10) Pub. No.: US 2012/0024887 A1
(43) Pub. Date: Feb. 2, 2012

(54) Liquid Butter Dispenser

(75) Inventor: Karl Heinze, West Chicago, IL (US)

(73) Assignee: PRINCE CASTLE LLC, Carol Stream, IL (US)

(21) Appl. No.: 12/845,912

(22) Filed: Jul. 29, 2010

(51) Int. Cl. B67D 7/00; B67D 7/60

(52) U.S. Cl. 222/1; 222/387; 222/323; 222/324

(57) ABSTRACT

Consistent volumes of viscous fluids are dispensed from a container configured to have a fixed volume, positive displacement pump assembly that receives and dispenses fixed volumes of the viscous liquids. Gravity causes viscous liquid in a container to fall through openings in a check valve. Pressure on the check valve by a user causes the valve to close. Additional pressure from the user drives the pump assembly downwardly to dispense captured liquid. The dispensed volume is controllable by controlling the displacement of an actuating lever Dispensing covers over the discharge holes prevent liquids from leaking out of the container.

### BACKGROUND

Many restaurants, food service providers and restaurant chains strive to make their products consistent in order to control costs but also because patrons expect menu items to be consistent, regardless of where a particular menu item is purchased or which employee prepared it. Prepared food product consistency is difficult to achieve if different processes are used to prepare the product, as often happens when different employees of a restaurant use different amounts of ingredients to prepare the same item.

One way to help achieve food product consistency is to use the same ingredients, in the same amount. Prepared menu items can be made consistent by preparing an item using the same amount of each ingredient. Seasonings and toppings that are applied to a food item either before or after it is cooked are often applied in different amounts by different employees. Butter and margarine are considered herein to be toppings.

Many restaurants and restaurant chains offer breakfast foods that include English muffins. Many restaurants offer English muffins with toppings that are applied by the restaurant and thereafter served to a customer.

Consistently applying the same amount of butter or margarine to an English muffin is time consuming and problematic because of the surface roughness of an English muffin. A method and apparatus by which a liquid or melted butter or margarine, or other liquid food product can be consistently applied to food products like English muffins would be an improvement over the prior art.

### BRIEF DESCRIPTION OF THE DRAWINGS

FIG. 1 is a side view of a dispenser of fluid products such as liquid or melted butter or margarine;

FIG. 2 is a perspective view of the dispenser shown in FIG. 1 looking downwardly into the container of the dispenser;

FIG. 3 is a perspective view of the bottom of the dispenser shown in FIG. 1 and showing dispensing valves through which a liquid food product passes;

FIG. 3A is an isolated view of the dispensing valves shown in FIG. 3;

FIG. 4 is another perspective view of the dispenser shown in FIG. 1, looking downwardly into the container and showing a pump at the bottom of the container which drives liquid food products outwardly and showing a piston actuating lever which extends across the container;

FIG. 5 is a cross sectional view of the dispenser shown in FIG. 1;

FIG. 6 is an exploded view of the dispenser;

FIG. 7 is an exploded view of the pump which captures a volume of the fluid product from the container and discharges it from the dispenser;

FIG. 8 is a cross sectional view of the pump shown in FIG. 7.

FIGS. 9(A)-9(F) depict the capture, enclosure, translation, and dispensing of a liquid product from the pump shown in FIGS. 7 and 8;

FIG. 10 is a cross sectional view of the dispenser with a pump displacement limiter;

FIG. 11 is a top view of the dispenser shown in FIG. 10;

FIG. 12 is a cross sectional view of the dispenser with an alternate embodiment of a pump displacement limiter; and

FIGS. 13A and 13B are isolated views of the pump displacement limiter.

### DETAILED DESCRIPTION

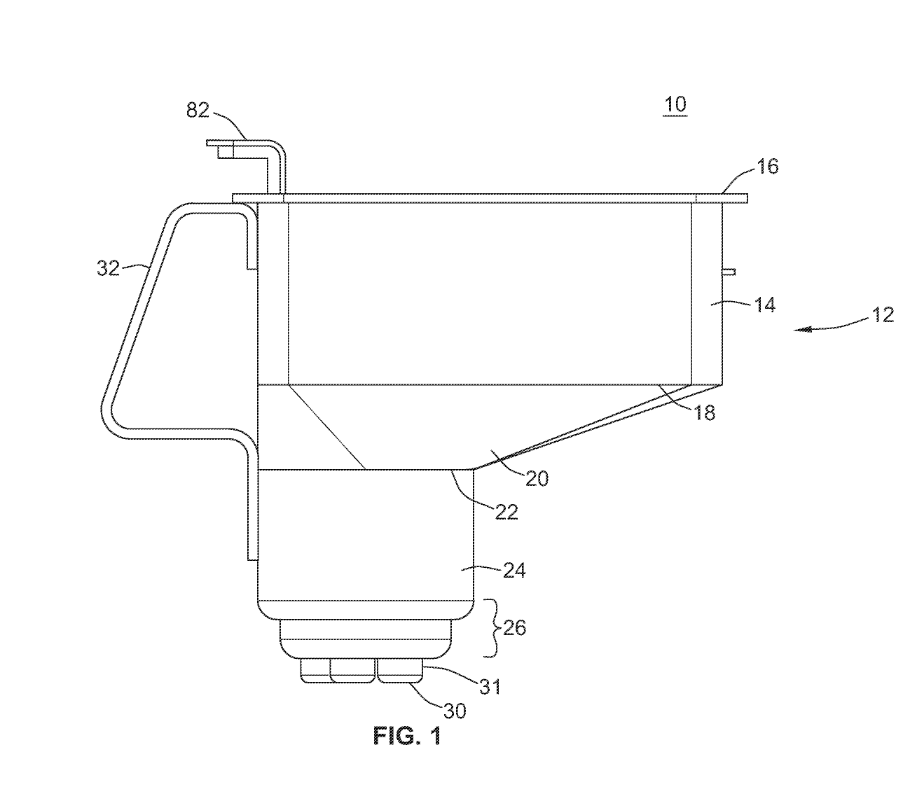

Reference is made to the accompanying figures. FIG. 1 is a side view of a dispenser 10 for relatively viscous fluid food products 10 that include melted butter and/or margarine and salad oil. The dispenser will work with fluids having other viscosities within a viscosity range of 1 to about 100,000 centipoise.

Viscosity is an internal property of a liquid that offers resistance to flow. In a sense, viscosity is liquid friction.

Viscosity is the inverse of fluidity, i.e., viscosity=1/fluidity. The unit of measure of viscosity is centipoise. 1 centipoise (cp)=0.01 dyne-sec/cm². The higher the coefficient of viscosity, the higher is the liquid's viscosity. Viscosity is also dependent upon temperature however. In general, the viscosity of a liquid varies inversely with the liquid's temperature. The higher the temperature of a liquid, the lower will be its viscosity. At room temperature, butter has a viscosity of about 50,000-75,000 cp. Melted butter on the other hand has a lower viscosity of about 1,000 up to about 5,000 cp.

Virtually any liquid with a viscosity of between about 1 cp up to about 100,000 cp can be dispensed using the dispenser disclosed herein but whether a liquid can be dispensed can also depend on a liquid's thixotropic characteristics.

Thixotropy is a property of various gels that become fluid when disturbed, such as by shaking Thixotropic means that a liquid's viscosity decreases as stress on the liquid increases. Substances which are thick like a solid, but which flow like a liquid when a sideways force is applied to them, are called thixotropic.

A thixotropic fluid undergoes a decrease in viscosity with time, while it is being subjected to constant shearing. Ketchup and mayonnaise are examples of thixotropic materials. Mayonnaise has a viscosity of about 28,000 cp; ketchup has a viscosity of about 75,000 cp. They appear thick or viscous, but can nevertheless be pumped because they are thixotropic.

The preferred embodiment of the dispenser 10 is comprised of a rigid container 12, preferably made of molded plastic or molded fiberglass. The container 12 has a top portion that is also referred to as a top part 14. The top part 14 has a shape reminiscent or suggestive of a rectangular parallelepiped, which is well known to be a six-faced polyhedron all of whose faces are parallelograms lying in pairs of parallel planes and wherein the faces of the polyhedron meet at right angles.

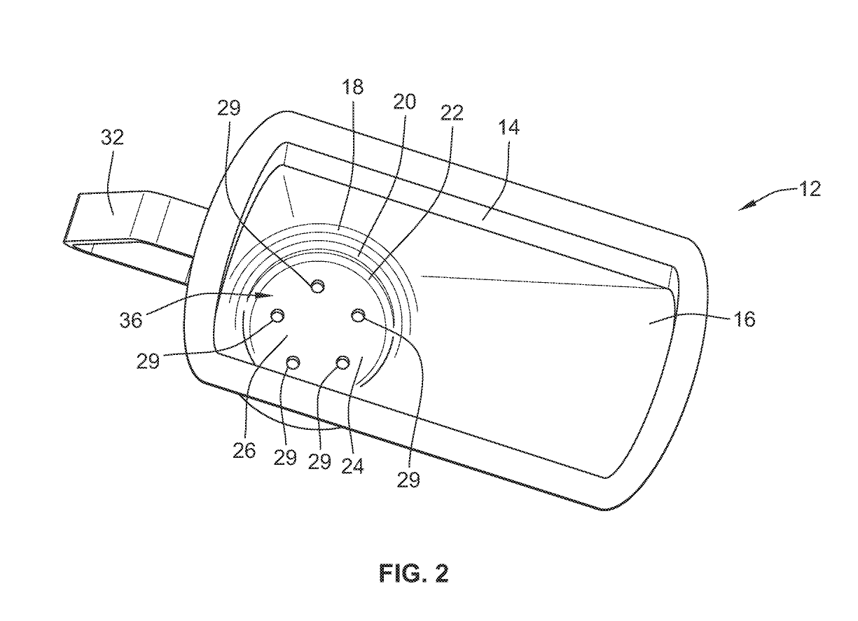

The top part 14 is hollow and has an open top 16, as can be seen in FIG. 1 and FIG. 2. The open top 14 allows fluid food products to be poured into the rigid container 12. Thixotropic liquids can be “scooped” into the open top 14.

The parallelepiped-shaped top part 14 has a bottom edge identified by reference numeral 18. The bottom edge is joined to, attached to, or formed with, a substantially funnel-shaped portion 20. The bottom edge 18 of the top part 14 corresponds to the top edge of the funnel-shaped portion 20.

The funnel-shaped portion 20 has a bottom edge 22, which is joined to, attached to, or formed with, a substantially cylindrical discharge portion 24. The bottom edge 22 of the funnel-shaped portion also corresponds to the top edge of the discharge portion 24.

As can be seen in FIGS. 1-3, the discharge portion 24 is cylindrical. It has a bottom portion 26 having a shoulder part that narrows the discharge portion 24. The bottom portion 26 is provided with several holes 29 through which fluid food products from the inside of the rigid container are discharged by the action of a pump assembly 40 located inside the discharge portion 24. A handle 32 is attached to one side of the top part 14 and to the discharge portion.

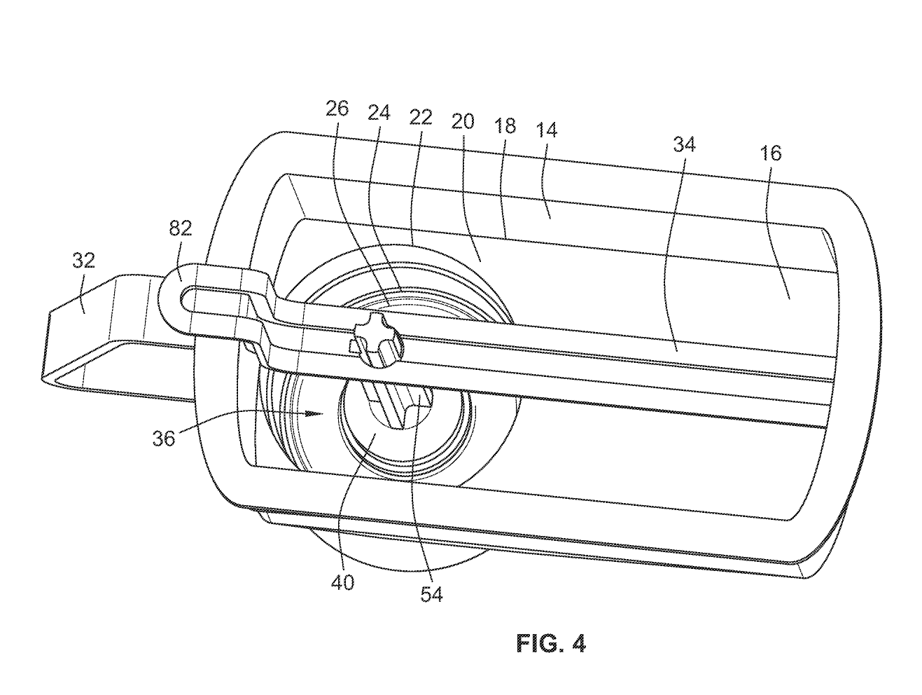

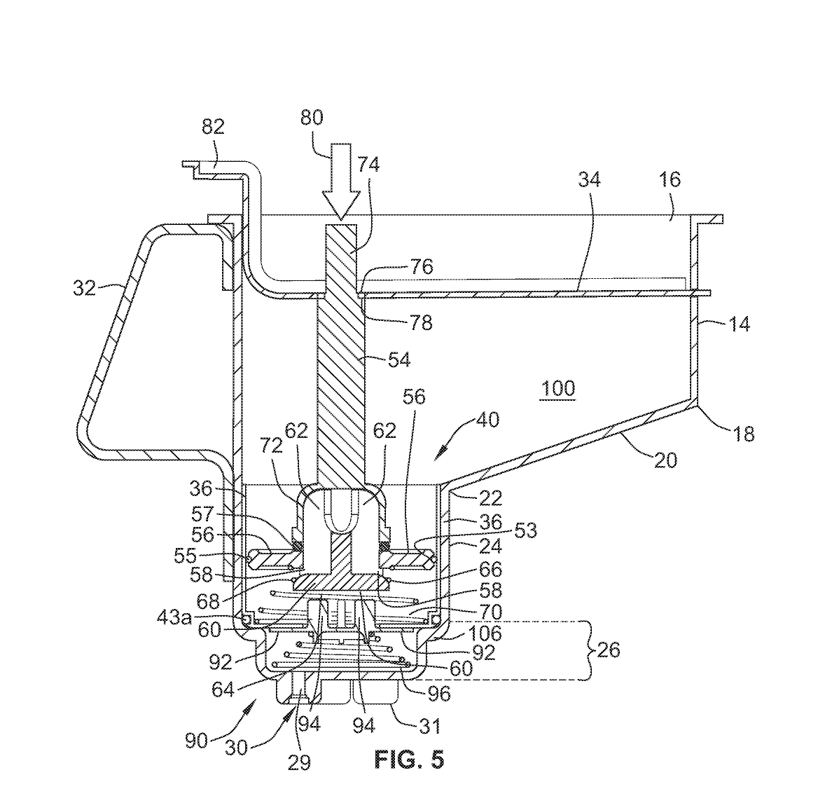

Fluid food products are dispensed from the dispenser 10 by grasping a handle 32 attached to one side of the rigid container 12 and depressing a tab 82, which is one end of a piston actuator 34, not visible in FIG. 1, 2 or 3 but seen best in FIGS. 4 and 5. The handle 32 is substantially “D” shaped, which facilitates a user grasping the handle 32 with four fingers and actuating the tab 82 with a thumb.

As can be seen in FIGS. 4 and 5, the piston actuator 34 is essentially a beam. The piston actuator 34 extends across the open top 16 of the parallelepiped-shaped top part 14. The distal end, which is away from the handle 32, is inserted into an opening formed in an opposite side wall of the top part 14.

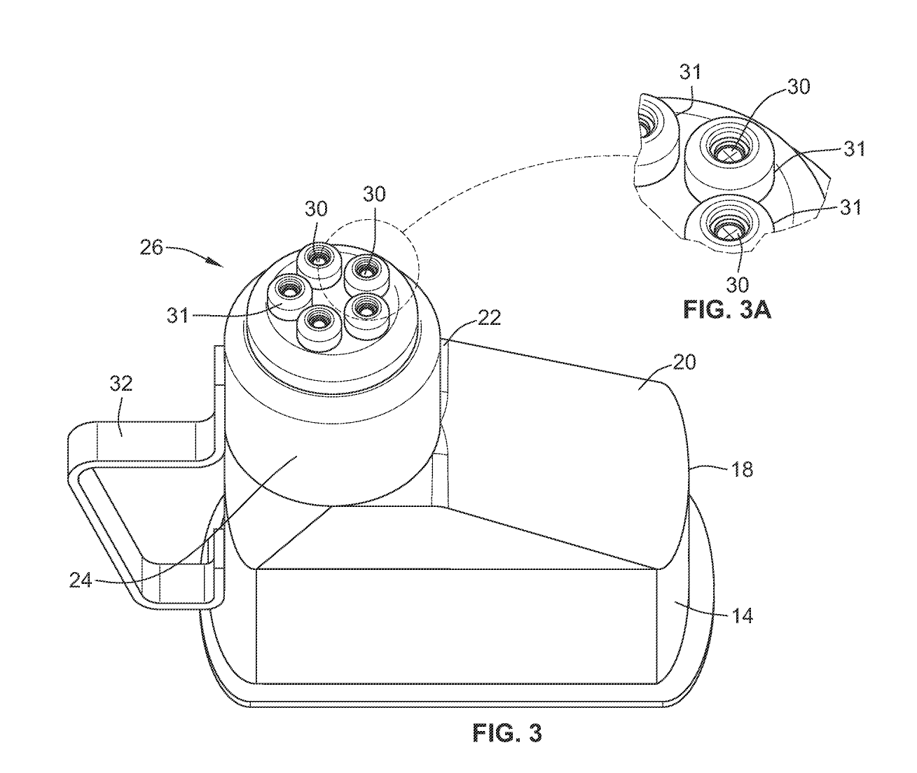

FIG. 3 shows that the bottom of the discharge portion 26 is comprised of protuberances 31 that extend from the bottom 26 of the discharge portion 30. The protuberances 31 have a shape reminiscent of a cylinder, on top of which is a zone of a sphere. A zone of a sphere is considered herein to be the portion of a sphere contained between two, spaced-apart parallel planes, which both intersect the sphere.

The protuberances 31 have relatively small diameter dispensing holes 29, which are covered by dispensing valves 30, such as the ones disclosed in U.S. Pat. No. 5,339,995, issued Aug. 23, 1994. The dispensing valves 30 are identified in the '995 patent by reference numeral 3. The contents of U.S. Pat. No. 5,339,995 are therefore incorporated herein in its entirety, as are the contents of U.S. Pat. No. 5,439,143 and U.S. Pat. No. 5,213,236.

Liquid and liquid food in the rigid container 12 is dispensed from the holes 29 and through the dispensing valves 30 using a pump assembly 40 inside the discharge portion 24. The pump assembly 40 is comprised of a holding cup 42, which fits inside a cylindrical interior portion of the discharge portion 24, and a piston assembly 52 that reciprocates up and down inside the cup 42. The cylindrical interior portion of the discharge portion 24 is hereafter referred to as a cylinder 36 inside the discharge portion 24.

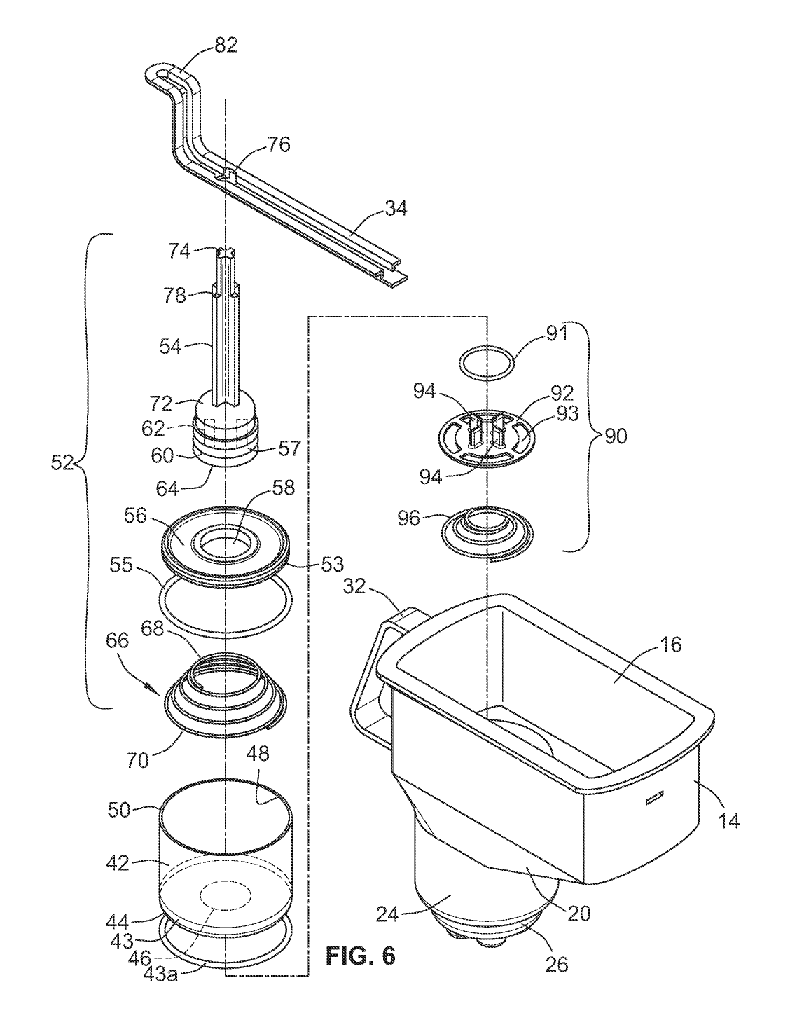

FIGS. 6, 7 and 8 show that the holding cup 42 is essentially a cylinder having an inside diameter, an outside diameter, a closed and substantially planar bottom 44 and an open top 50. The outside diameter of the cup 42 is selected so that the cup 42 fits snugly inside the cylinder 36. The “closed” planar bottom 44 is provided with a hole 46, through which liquid food products are discharged into the discharge portion 26.

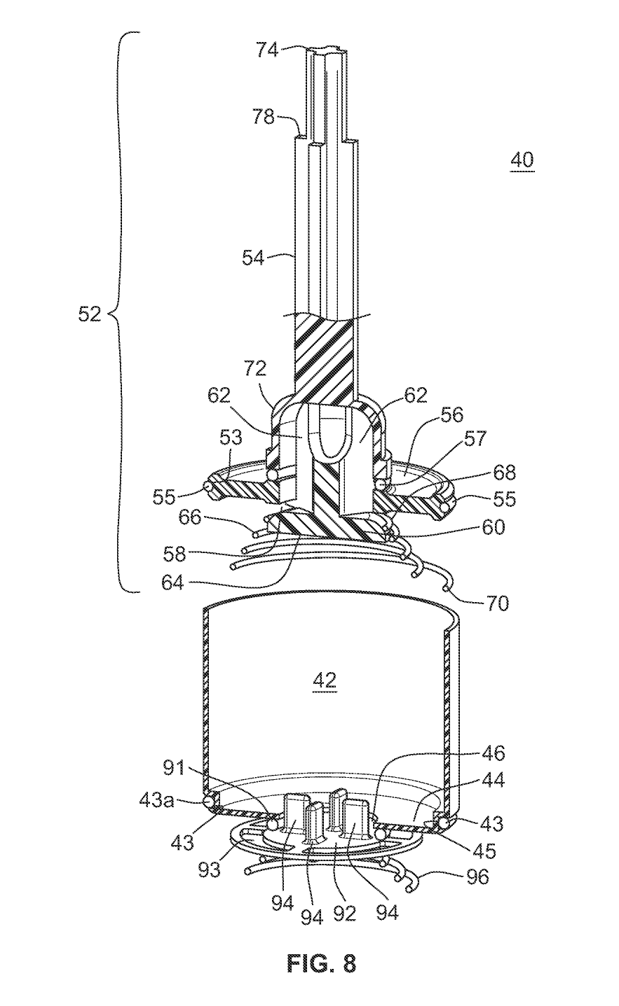

As stated above, the cup 42 fits snugly into the cylinder 36 formed into the inside of the discharge portion 24. The holding cup 42 therefore does not move in the cylinder 36. As best seen in FIG. 8, the outside bottom edge of the cup 42 is provided with a shoulder or chamfer identified by reference numeral 43. The chamfer 43 is configured to receive an O-ring or gasket identified by reference numeral 43a. The O-ring 43a is made of a pliable material such as neoprene or the like. It provides a seal, which prevents fluid that seeps between the outside surface of the cup 42 and the cylinder 36 from leaking into the holes 29 formed into the bottom 26 of the discharge portion 24 and accumulating above the dispensing valves 30 where it might leak onto a surface that supports the dispenser 10.

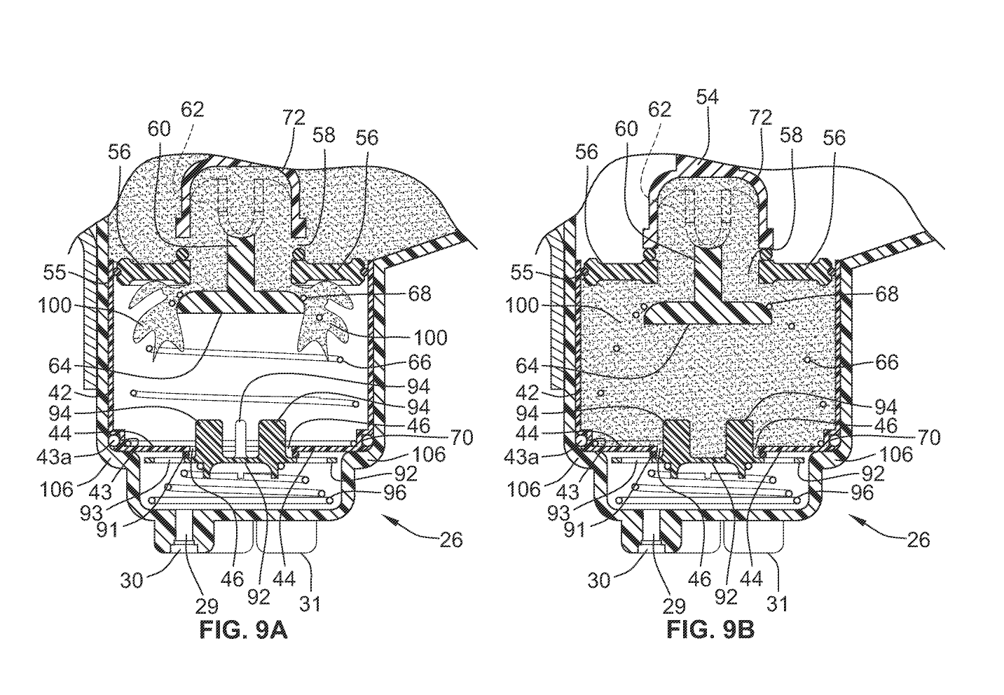

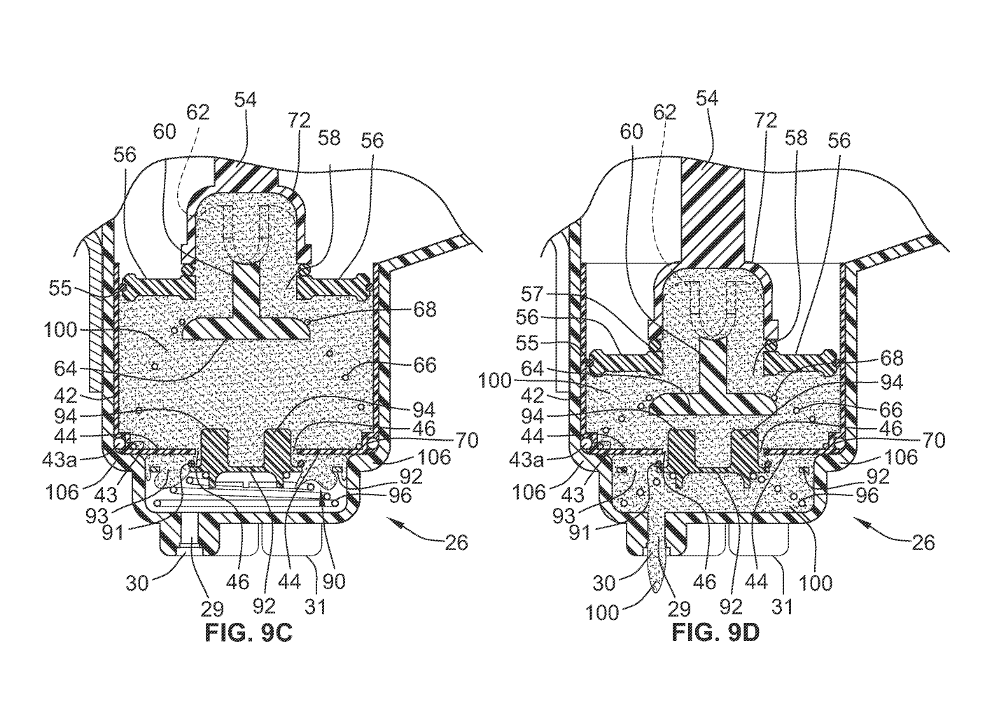

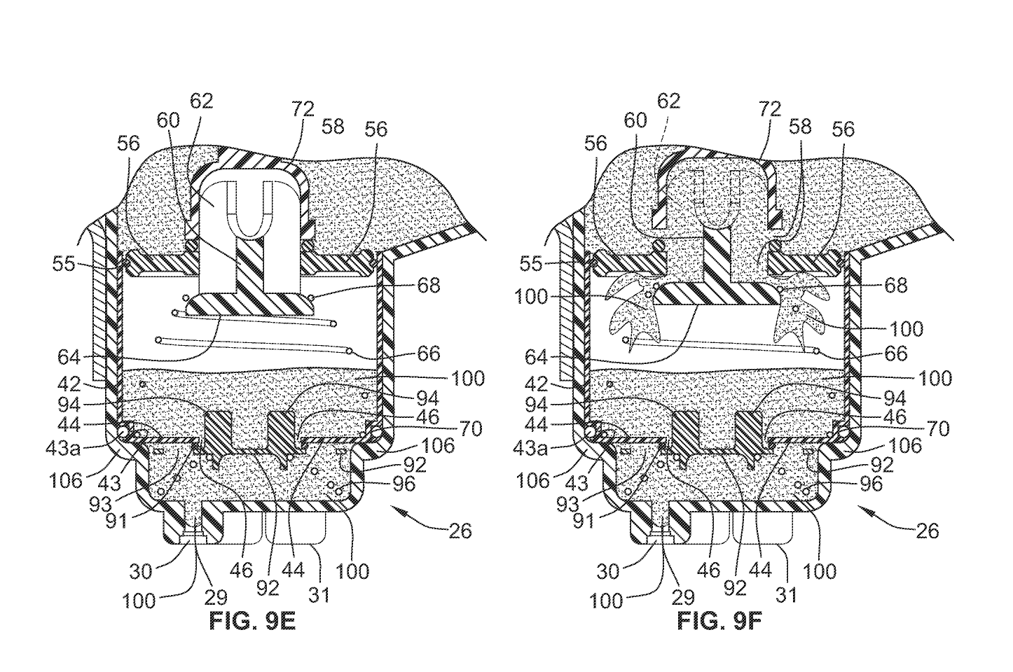

The inside diameter of the cup 42 is selected to receive a piston assembly 52 best seen in FIGS. 6, 7 and 8. The piston assembly 52 is configured to reciprocate up and down inside the cup 42. As shown in FIGS. 9A-9F and as described below, up and down movement of the piston assembly 52 in the cup 42 captures liquid from the container 12, seals it inside the cup 42 and drives the captured liquid/fluid through the hole 46 in the bottom of the cup 42, through the holes 29 formed in the protuberances 31 and out through the dispensing valves 30.

The piston assembly 52 moves downward in response to downward force exerted on the piston assembly 52 through the piston actuator 34. The piston assembly 52 moves upward in response to an upward force exerted on the piston assembly 52 by a coil-type piston return spring 66, which forms part of the piston assembly 52.

As best seen in FIGS. 6, 7 and 8, the piston assembly 52 is comprised of a push rod 54 having a top end 74 and a bottom end, which is formed as a hemispherical-shaped cap 72. The piston assembly 52 is also comprised of a disk 56, a first check valve and the coil-type piston return spring 66.

As mentioned above, the piston actuator 34 is essentially a beam, one end of which fits loosely into a hole formed into one side of the rigid container 12, the other end of which is formed to extend over the user handle 32. As can be seen in FIGS. 4, 5 and 6, the piston actuator 34 is provided with a hole that receives the top end 74 of the push rod 54. The top end 74 of the push rod is narrowed to fit into the hole in the piston actuator 34 and to form a wider, shoulder 76. Downward force applied to the user-actuating tab 82 of the piston actuator 34, is therefore applied against the shoulder 76, driving the push rod 54 downward. Driving the push rod 54 downward therefore drives the hemispherical cap 72 downward. Driving the cap 72 downward pushes the disk 58, check valve and spring 66 downward and further into the cup 42.

Referring now to FIGS. 6, 7 and FIG. 8, the pump assembly 40 can be seen to be comprised of the fluid product holding cup 42 and the piston assembly 52. Fluid from inside the rigid container 12 flows into the cup 42 through a check valve 51, which is comprised of a stopper 60, which translates up and down in the hole 58 formed into the disk part 58 of the piston assembly 52.

As can be seen in the figures, the top 50 of the cylinder 48 that comprises the cup 42 is open. The cylinder 48 has an inside diameter selected to receive the piston assembly 52 into the open top 50 of the cylinder 48 and to permit the piston assembly 52 to freely move up and down in the cylinder 48. The cup 42, container 12 and piston assembly 52 are configured such that when the piston assembly 52 is at or near the top 50 of the cup 42, the level of the “bottom” of the fluid in the container 12 is above the cup 42 and above the piston assembly 52. A check valve in the piston assembly 52 allows fluid from the container 12 to flow into the cup 42 until the cup 42 is full. Downward force on the push rod 54 closes the check valve in the piston assembly 52 and drives the piston assembly downward in the cup 42, against fluid that flowed into the cup 42 while the first check valve was open.

A second check valve 90 is operatively coupled to the hole 46 in the bottom 44 of the cup 42. The second check valve 90 is normally closed until a downward force exerted on the second check valve 90, through the captured fluid in the cup 42, is great enough to open the second check valve 90. When the second check valve 90 opens, fluid in the cup 42 flows through the hole 46, out of the cup and into the discharge portion 24. Additional force on fluid that flows into the discharge portion 24 from the cup will drive the fluid in the discharge portion 24, into holes 29 formed in the bottom 26 of the discharge portion 24 and through the dispensing valves 30 that cover and seal the holes 29.

The first check valve 51 is comprised of a relatively thin, substantially planar rigid disk 56 having a central hole 58, a stopper 60 which moves up and down in the central hole 58, and the hemispherical cup 72. The disk 56 has an outside diameter slightly less than the inside diameter of the cup 42 so that the disk 56 can freely translate up and down, i.e., reciprocate, inside the cup 42 but also be able to force or drive fluid out of the cup 42 in response to force applied to the piston assembly 52. A groove 53 is preferably formed into the peripheral edge of the disk 56. The groove 53 is sized, shaped and arranged to receive an O-ring 55, which improves the seal between the disk 56 and the inside surface of the cylinder 48 of the cup 42. The O-ring 55 is, of course, preferably made of a pliable material suitable for use with food products and the material from which the dispenser parts are made.

The hole 58 that extends through the disk 56 has a predetermined diameter, selected to freely receive the stopper 60. The stopper 60 has a round and substantially planar, disk-like bottom end 64. Four, L-shaped prongs 61 extend “upwardly” from the planar bottom end 64 and have a predetermined length, which is selected such that when the stopper 60 is installed in the disk 56, the vertical portions the L-shaped prongs 61 extend through the hole 58 in the disk 56 and are able to extend to the top of the inside surface of the cap 72. The top of the vertical portions of the L-shaped prongs 61 define a top end 62 of the stopper 60. The stopper 60 is preferably molded from a plastic that is sufficiently flexible to allow for the insertion of the prongs into the hole.

While the top end 62 of the stopper 60 extends into the cap 72, the bottom 64 of the stopper 60 contacts the top end 68 of the coil-type piston spring 66. The bottom end 70 of the spring 66 works against the bottom 44 of the cup 42. The characteristics of the spring 66 are selected in order to be able to push the disk 56 and the stopper 60 upwardly and away from the bottom 44 of the cup 42, when there is no downward force applied to the piston assembly 52 by the piston actuator 34.

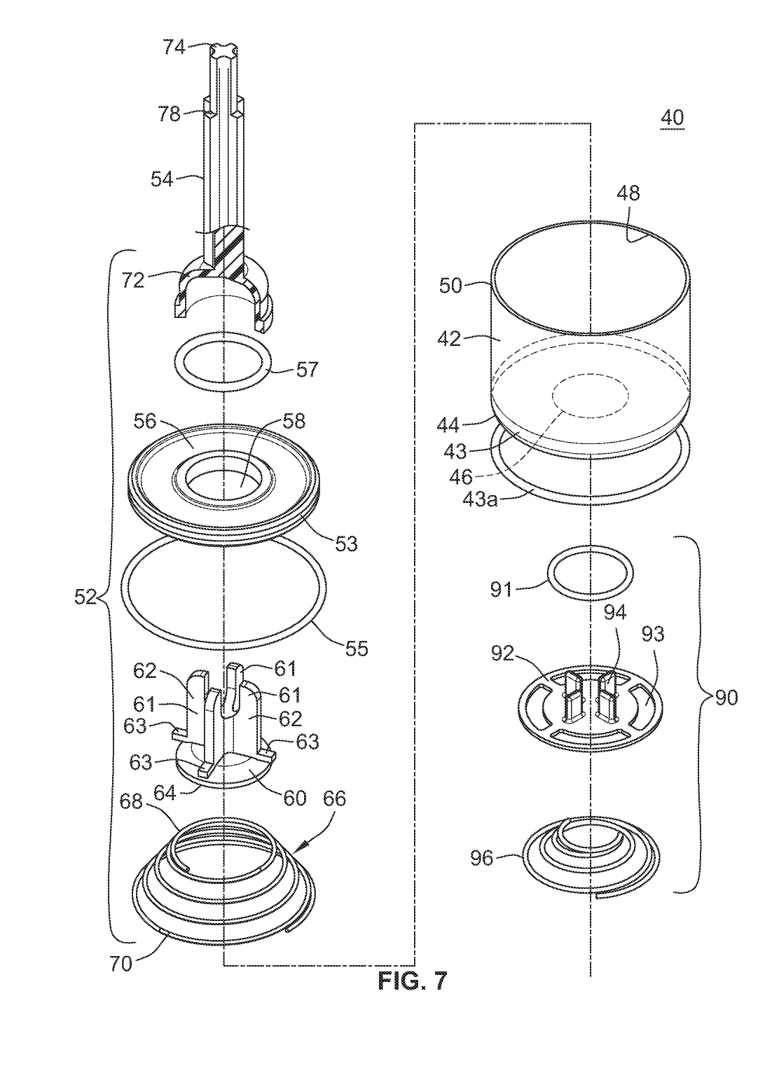

As best seen in FIG. 7, the horizontal portions 63 of the L-shaped prongs 61 have a height, relative to the surface of disk-like bottom end 64. The height of the horizontal portions 63 of the prongs 61 prevent the disk-like bottom end 64 from making contact with the lower surface of the disk 56, which would close the hole 58. The horizontal portions 63 of the prongs 61 thus keep the hole 58 “open” by holding the bottom end 64 of the stopper 60 away from the disk 56.

The prongs 61 of the stopper 60 and the diameter of the hole 58 are selected so that the stopper prongs 61 fit loosely inside the hole 58. The loose fit of the stopper prongs 61 thus allows the stopper 60 to move up and down in response to forces applied to it by the hemispherical cup 72 and the coil spring 66.

The first coil spring 66, which is located below the bottom end 64 of the stopper 60 and above the bottom of the cup 42, applies an upward force against the bottom end 64 of the stopper. When the horizontal portions 63 of the L-shaped prongs 61 engage the bottom face of the disk 56 due to the upward force from the spring 66, the same force is transmitted through the stopper 60 to the disk 56, push rod 34 and the piston actuator 34.

In FIG. 5, the arrow identified by reference numeral 80 is a vector representing downward force applied (by a user) to an actuating tab 82. Driving the piston actuator 34 downward drives the push rod 54 downwardly. Driving the push rod 54 downward will drive the top end 62 of the stopper 60 downward and against force applied to the stopper 60 by the first coil spring 66. In order to drive the piston assembly 52 downward, the force exerted on the cap 72 needs to at least overcome the upward force provided by the spring 66. It also needs to overcome friction between the O-ring 55 and the cylinder 48, as can be seen in FIG. 7.

When the cap 72 is driven downward, it eventually meets the top surface of the disk 56. Since the inside diameter of the hole 58 through the disk 58 is less than the inside diameter of the cup 72, the cup 72 effectively covers and closes the hole 58 in the disk 56 when the cup 72 meets the top surface of the disk 56. When the hole 58 is closed, fluid in the container 12 cannot flow into the cup 42. An optional O-ring 57, formed of a soft, pliable material suitable for use with a food product, is therefore sized and shaped to fit around the prongs 61 of the stopper 60. The O-ring 57 is placed between the disk 56 and the cap 72 to enhance the seal between the cap 72 and the disk 56 when the cap 72 is driven downwardly and into engagement with the disk 56.

As mentioned above, the first coil spring 66 biases or urges the stopper 60 upwardly. When the stopper 60 is pushed upwardly, the top end 62 of the stopper 60 pushes against the hemispherical cap 72. If the force from the coil spring 66 is greater than downward force applied through the cup, as happens when a user releases the user actuating tab 82, the cap 72 is moved upwardly and away from the disk 56, opening the first check valve 52, by exposing the hole 58 in the disk 56 to liquid inside the container 12.

The volume of the cup 42 below the disk 56 and above the planar bottom 44 of the cup 42 defines a maximum volume that can be captured inside the piston. As mentioned above, captured liquid is considered to be liquid that flows into the cup 42. Fluid in the cup is “captured” in the cup 42 when the first check valve 52 closes. The first check valve 52 closes when the cap 72 is pushed downwardly and into engagement with the top of the disk 56, closing the hole 58. Captured fluid in the cup 42 is translated downwardly in the cup 42, through the hole 48 in the bottom 44 of the cup 42, into the bottom 26 of the discharge portion 24 and out of one or more holes 29 formed into the bottom 26 of the discharge portion 24, by the application of additional downward force on the cap 72 via the push rod 54/user actuating tab 82.

A second check valve 90 is provided at the bottom of the cup 42. The second check valve 90 is configured to open and allow fluid to flow out of the cup 42 and into the discharge portion 24 in response to downward force applied to liquid in the cup 42 from the piston assembly 52. The second check valve 90 closes when the piston assembly 52 moves upward in the cup, i.e., away from the bottom of the cup 42. It thus prevents fluid from being drawn up into the cup 42.

As best seen in FIGS. 7 and 8, the second check valve 90 is comprised of a substantially planar disk 92, having a stopper portion 94 that extends upwardly through a hole 46 formed in the planar bottom 44 of the cup 42. This second disk 92 also has four, partial-annulus openings 93 that allow fluid from the hole 46 to flow through the disk 92.

A second coil spring 96 is located below the bottom of the stopper 94 and above the bottom 26 of the discharge portion 24 to bias the stopper 94 upwardly. When the second planar disk 92 portion of the second stopper 94 is biased against the bottom 44 of the cup 42, the hole 46 in the bottom 44 of the cup 42 is sealed.

The second spring 96 is compressed downwardly and the hole 46 opened when hydrostatic pressure inside the cup 42 exceeds the force applied to the planar disk 92 by the second spring 96. Stated another way, when the hydrostatic force applied to a fluid product inside the cup 42 exceeds the force applied to the planar disk 92 of the second stopper 94, the planar disk 92 will be urged downwardly and away from the planar bottom 44 of the cup 42. Liquid inside the cup 42 is thereafter driven through the hole 46 and into the discharge openings 29 formed in the bottom 26 of the discharge portion 24.

The disk 56 and cup 42 are configured such that the disk 56 fits snugly in the cup 42. Upward movement of the disk 56 will thus create a negative pressure inside the cup 42. Negative pressure, i.e., a partial vacuum, inside the cup 42 will slow the disk's upward movement, but a negative pressure inside the cup 42 will also draw liquid from the container 12 into the cup 42 through the hole 58. When downward force/pressure is released, the spring will overcome the partial vacuum and allow the assembly to return to its quiescent or starting position.

FIGS. 9A, 9B, 9C, 9D and 9E collectively show how the dispenser 10 operates to dispense fluid. In FIG. 9A, the cap 72 is away from the disk 58 because no force is applied to the push rod 54. The horizontal portions of the L-shaped prongs 61 of the first stopper 60 hold the bottom end 64 of the stopper 60 away from the disk 56. Liquid 100 in the container 12 flows into the cup 42 through the hole 58 in the disk 56.

In FIG. 9B, downward force on the push rod 54 drives the hemispherical cap 72 downward. The cap 72 covers and closes the hole 58. When the hole 58 is closed, liquid 100 inside the cup 42 is captured.

In FIG. 9C, additional downward force through the push rod 54 drives the hemispherical cap 72 farther down. Pressure below the piston assembly 52 and inside the cup 42 increases the hydrostatic pressure inside the cup 42 until the bias force applied by the second spring 90 is overcome and the second stopper through the hole in the bottom of the cup 42 is pushed downwardly, opening the hole in the bottom of the cup 42. Liquid 100 inside the cup 42 is thereafter pushed through the holes 93 in the disk 92 and into the discharge portion 24 below the bottom 44 of the cup.

Additional hydrostatic pressure drives the liquid 100 completely down into the discharge portion and out of the discharge opening 30 as shown in FIG. 9D. Continued downward force 104 on the push rod 54 eventually empties the contents of the piston 40. Since the volume inside the cup 42 is fixed, repeated cycling of the piston assembly 52 results in a constant or nearly-constant volume of liquid 100 being discharged on each complete actuation of the piston actuator 34.

The pump assembly 40 is in reality a positive displacement pump. Its displacement on each actuation, and hence the volume of liquid that is dispensed on each actuation of the piston actuator 34, is a function of the diameter of the cup 42 and the length of the stroke of the piston assembly 52 in the cup 42. The volume of liquid that is dispensed on each actuation can therefore be selectively controlled, i.e., changed by a user, by limiting the piston assembly 52 travel in the cup 42. The volume of a cylinder is defined by: V=π r²h=π(d/2)²h, where r=inside radius of a cylinder, d=diameter of a cylinder, h=height of cylinder or stroke

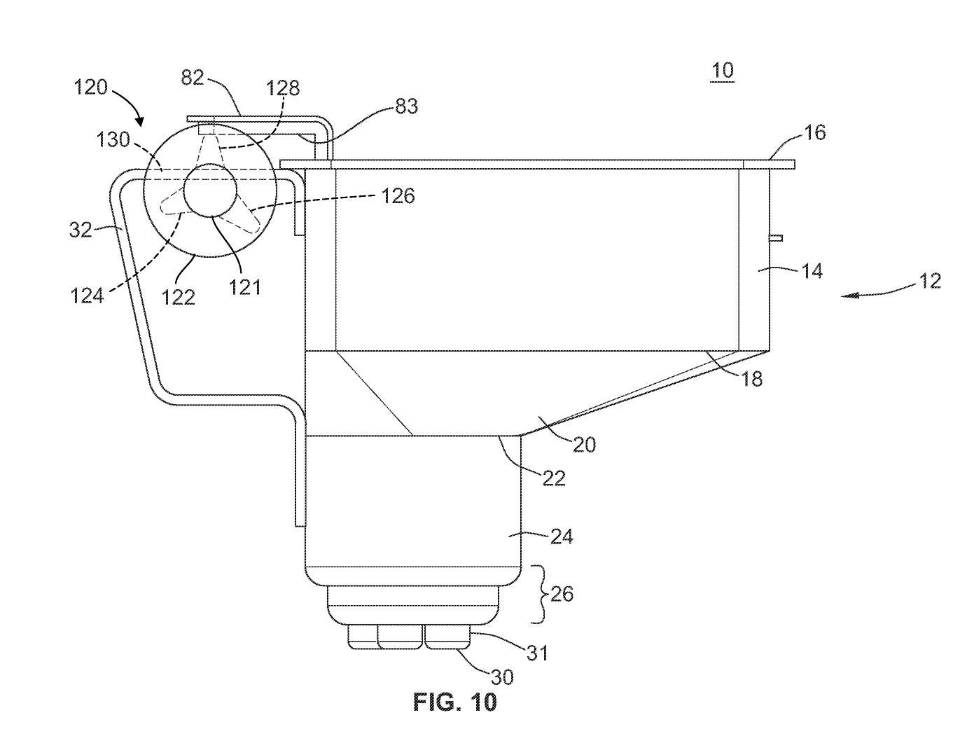

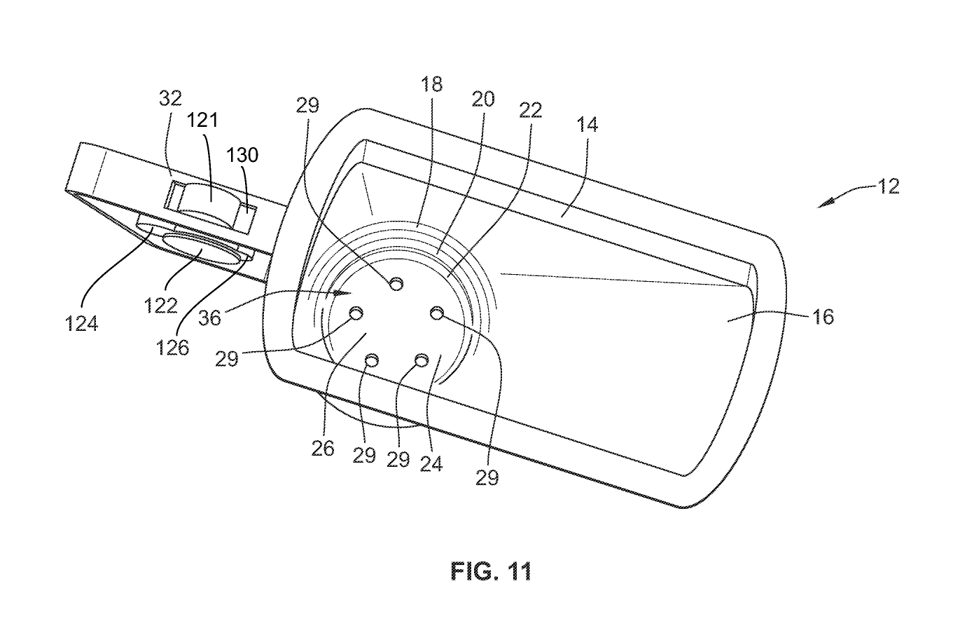

FIG. 10 is a cross sectional view of a liquid butter dispenser that also depicts a first embodiment of a pump displacement limiter 120. FIG. 11 is a top view of the dispenser shown in FIG. 10 with the piston actuator 34 removed.

The pump displacement limiter 120 shown in FIGS. 10 and 11 is embodied as a rotatable hub 121 that is rotatably attached to the handle 32. Three lobes 124, 126 and 128, each having a different height, extend outwardly from the hub 121. A thumbwheel 122 is attached to one end of the hub 121. Rotation of the thumbwheel 122 rotates the hub 121. Rotation of the hub 121 positions a different one of the lobes 124, 126 and 128 under the tab 82. The maximum downward deflection of the tab 82 is thus limited by the particular lobe 124, 126 and 128 that is rotated under the tab 82 by rotation of the thumbwheel 122.

Reducing the downward travel distance of the actuator 34 by the height of the lobes 124, 126 and 128 reduces the piston assembly 52 stroke length in the cup 42 accordingly. Reducing the piston assembly stroke length, reduces how much liquid is dispensed each time that the piston actuator 34 is depressed. By controlling the piston stroke travel using discrete distances defined by the different lobes, the limiter 120 in FIGS. 10 and 11 defines specific amounts of liquid that can be dispensed on each actuation of the piston assembly depending on which lobe is rotated into position.

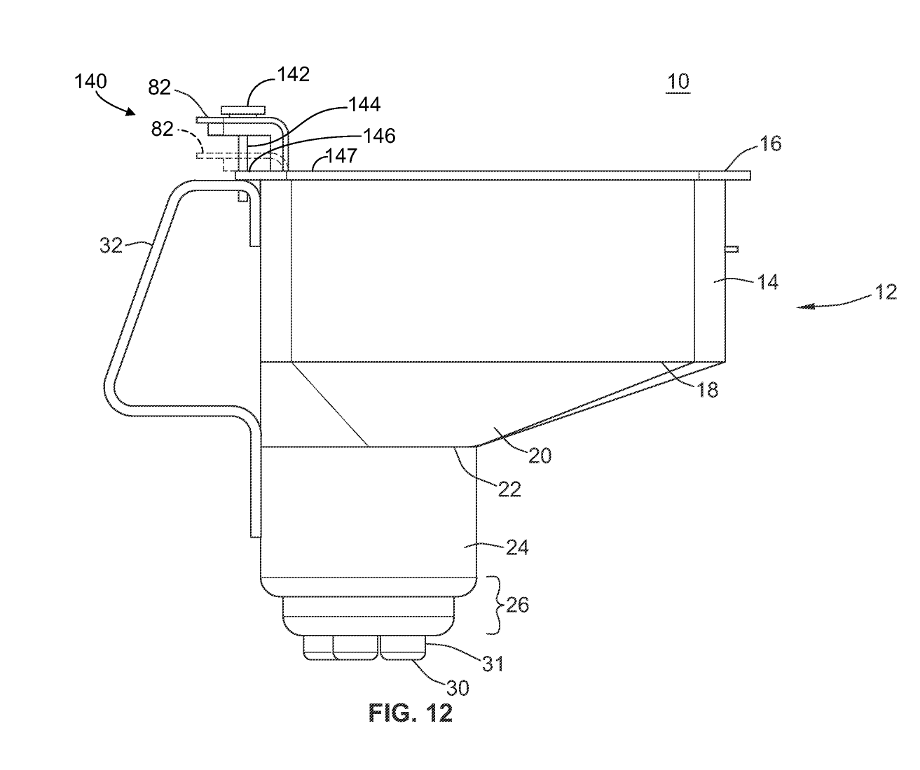

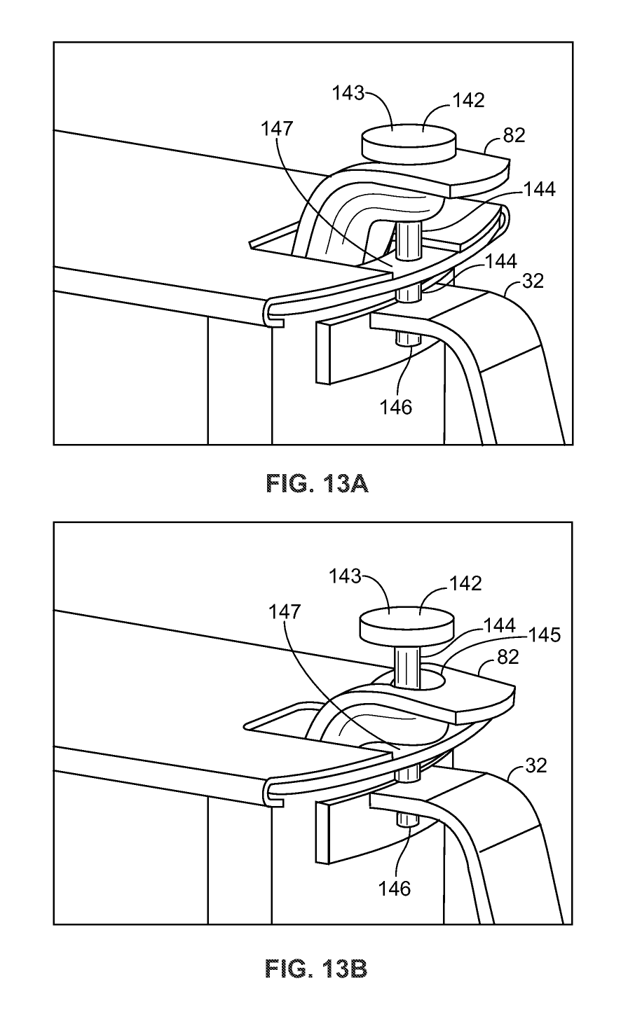

FIG. 12 and FIGS. 13A and 13B depict an alternate embodiment of a pump displacement limiter 140, and which can control the amount of liquid dispensed on each actuation, continuously. In FIGS. 12, 13A and 12B, a thumbscrew 142 limits the distance that the piston actuator 34 can travel upwardly, which controls the amount of fluid that can be captured by the piston.

The thumbscrew 142 has a threaded shank 144, which extends through a slot 145 formed into the actuating tab 82. The thread on the shank 144 mate with and engage a threaded hole 146 that extends through the flat lip 147 surrounding the open top 16. Rotating the head 143 of the screw 142 causes the screw 142 and screw head 143 to move up and down in the threaded hole 146, relative to the lip 147.

In FIG. 13A, the actuating tab 82 is shown in an “up” position, resting against the bottom of the head 143 of the thumbscrew 142. In FIG. 13B, the user actuating tab 82 is shown in a “down” position, resting against the flat lip 147 surrounding the open top 16. The up and down distance that the user actuating tab 82 travels limits the amount of fluid captured by the piston assembly. The volume of liquid discharged by each actuation of the tab 82 is thus controlled by controlling the vertical travel of the user actuating tab 82 with the volume of dispensed liquid being continuously variable depending on the position of the thumbscrew.

Those of ordinary skill in the art will recognize that clearances between the side wall of the cup 42 and cylinder 36 that the piston 40 translates in will allow material inside the rigid container to leak past and settle at the bottom 26 of the discharge portion 24. An accumulation of the material will eventually leak through the discharge openings 30 unless a closure is provided to retain the liquid inside the discharge openings. An effective dispensing valve is disclosed in U.S. Pat. No. 5,439,143, which is entitled “Dispensing Valve for Packaging.” The '143 patent issued on Aug. 8, 1995, the term of the patent subsequent to May 25, 2010, was disclaimed. The contents of the '143 are incorporated herein in their entirety.

An additional dispensing valve is disclosed in U.S. Pat. No. 5,339,995 which issued Aug. 23, 1994, and which is entitled, “Dispensing Valve for Packaging.” The contents of the '995 patent are also incorporated herein in its entirety.

Descriptions of the structure and operation of the dispensing valves 110 depicted in FIG. 3, as being attached to and extending over the discharge openings 30, control the flow of liquid product from those discharge openings 30. A complete description of their operation and structure can be found in the aforementioned '995 patent and or the '143 patent. A detailed description of them is omitted for brevity.

The foregoing description is for purposes of illustration only. The true scope of the invention is set for in the appurtenant claims.

What is claimed is:

1. A dispenser for fluid products, comprising:
a container having a discharge portion, having a first discharge opening through which fluid products from the container are dispensed;
a cup within the discharge portion, the cup forming a cylinder, the cup being configured to receive fluid products from the container;
a pump assembly within the cylinder, the pump assembly comprised of:
a piston assembly which translates in the cylinder between first and second positions, the piston assembly being comprised of a disk having a diameter which fits within the cylinder and, a first check valve, the disk and check valve being configured to capture fluid product in the cup when the piston assembly is at said first position and, discharge captured fluid through a discharge opening in the cup as the piston assembly moves from the first position toward the second position; and
a dispensing valve attached to the first discharge opening and controlling the flow of the fluid product from said discharge opening.

2. The dispenser of claim 1, wherein the disk is comprised of;
a circumferential groove; and
an O-ring within the circumferential groove.

3. The dispenser of claim 1, wherein the disk has a hole and wherein the first check valve is comprised of a stopper having first and second ends and which extends through the hole and translates in the hole between third and fourth positions, the stopper allowing fluid to flow from the container, through the hole and into the cup when the stopper is at the third position, the stopper closing the hole and capturing fluid in the cup when the stopper is at the fourth position, the stopper being at the fourth position as the piston assembly is driven from the first position to the second position.

4. The dispenser of claim 3, wherein the piston assembly is comprised of a push rod and a hemispherical cap that receives a first part of the stopper, the cap extending over the hole and closing the hole when a force is applied to the hemispherical cap to drive the stopper from the third position to the fourth position.

5. The dispenser of claim 4, further comprised of an O-ring between the hemispherical cap and the disk.

6. The dispenser of claim 1, further comprising piston actuating lever, configured to exert a downward force on the piston assembly and to drive the piston assembly from the first position to the second position and to drive the stopper from the third position to the fourth position.

7. The dispenser of claim 6, wherein the first and second positions are separated from each other by a first distance, the first distance and inside diameter of the cup defining an amount of liquid to be dispensed.

8. The dispenser of claim 1, wherein the dispensing valve is comprised of:
a marginal portion sealing about the discharge opening of said container and, a head portion including a central area with an orifice which opens to permit fluid flow there through in response to a predetermined discharge pressure within said discharge portion, and which closes to shut off fluid flow there through upon removal of the predetermined discharge pressure;
said head portion having an exterior surface which interfaces with ambient environment and has at least, at outer portions thereof, an inwardly curving arcuate side elevational shape defined by a first radius, and an interior surface which interfaces with the fluid product in said container and has at least at outer portions thereof an inwardly curving arcuate side elevational shape defined by a second radius, which is greater than said first radius, such that said exterior and interior surfaces converge toward the central area of said head portion to provide a tapered construction with reduced thickness adjoining said orifice.

9. The dispenser of claim 1, wherein the container is comprised of a plurality of discharge openings through which fluid products from the container can pass and wherein each discharge opening is provided with a dispensing valve.

10. The dispenser of claim 1, wherein the cup is further comprised of:
a substantially planar bottom, having a second discharge hole;
a second check valve operatively coupled to the second discharge hole; and
an open top opposite the substantially planar bottom and facing the container.

11. The dispenser of claim 10, wherein the second check valve is comprised of:
a second elongated stopper that extends through the hole in the bottom of the cup, the second stopper having first and second ends, the first end of the second elongated plug being on a first side of the disk, the second end of the second elongated plug being on an opposite second side of the disk;
a second coil spring within the cup and located between the bottom of the cup and the second end of the second stopper.

12. The dispenser of claim 1, wherein the dispenser is configured to dispense a fluid product that is at least one of:
liquefied margarine; and
liquefied butter.

13. The dispenser of claim 1, wherein the dispenser is configured to dispense fluid product having a viscosity range between about 1 and about 1000 centipoise.

14. The dispenser of claim 1, wherein the dispenser is configured to dispense fluid product having a viscosity range between about 100 and about 100,000 centipoise.

15. The dispenser of claim 1, wherein the dispenser is configured to dispense thixotropic liquids.

16. The dispenser of claim 1, further comprising a piston travel limiter for said piston assembly, the piston travel limiter being configured to limit the distance that the piston assembly travels in the cylinder.

17. The dispenser of claim 16, wherein the piston travel limiter is configured to limit the downward travel distance of the piston assembly to one of a plurality of fixed distances, each of the plurality of different, fixed distances corresponding to different fixed volumes of fluid product that are dispensed when the piston assembly travels the first distance.

18. The dispenser of claim 17, wherein the piston travel limiter is comprised of:
a rotatable cam having a plurality of different-height lobes, each of which defines a distance that the piston assembly can travel in the cylinder.

19. The dispenser of claim 16, wherein the piston travel limiter is configured to continuously vary the travel distance of the piston assembly.

20. The dispenser of claim 19, wherein the piston travel limiter is comprised of:
a rotatable thumbscrew.

21. A method of dispensing a liquid food product from a container having a top portion, a bottom portion and configured to retain a fluid product therein, the container also having a cylindrical discharge portion located at the bottom portion of the rigid container, the cylindrical discharge portion comprised of a pump assembly, which is comprised of a first cylinder having a first end proximate the bottom portion of the container and a second end having a discharge opening through which fluid products from the container can pass, the method comprising the steps of:
capturing liquid in a piston, which reciprocates in the first cylinder between first and second ends of the first cylinder, the piston being configured to capture a predetermined volume of fluid product from the container; and
applying a force to the piston to move the piston and captured fluid from the first end of the first cylinder toward the second end of the first cylinder, responsive to the force exerted on the piston; and
maintaining force on the piston to dispense liquid food product from the rigid container.

22. The method of claim 21, wherein the step of applying force to the piston is comprised of:
applying a downward force to a piston actuating lever, which extends at least part way across the top portion of the rigid container.

23. The method of claim 21, wherein the step of applying a force to the piston is comprised of applying the downward force through a piston rod which extends downwardly from the piston actuating lever to the piston.

24. The method of claim 21, wherein the step of capturing liquid in a piston comprises:
receiving fluid into the piston from the container through a first check valve operatively coupled to the piston and configured to admit fluid product into an interior portion of the piston.

25. The method of claim 21, wherein the liquid food product has a viscosity range between 1 and about 1000 centipoise.

26. The method of claim 21, wherein the liquid food product has a viscosity range between about 1 centipoise up to about 100,000 centipoise.

27. The method of claim 21, wherein the step of applying a force to the piston is comprised of the steps of:
moving the piston and captured fluid from the first end of the first cylinder toward a second position within the first cylinder, the movement of the piston from the first end to the second position effectuating the dispensing of a predetermined volume of the liquid food product.

28. The method of claim 27, wherein the second position is separated from the first end of the first cylinder by a user-selectable distance.

29. The method of claim 25, wherein the user-selectable distance is selected by a user-operable piston travel limiter.

30. The method of claim 26, wherein the step of capturing liquid in a piston includes the step of capturing liquid food that exhibits thixotropic behavior.
